(19) United States
(12) Patent Application Publication
(10) Pub. No.: US 2021/0388295 A1
(43) Pub. Date: Dec. 16, 2021

(54) WATER-SOLUBLE MULTI-CHAMBER CONTAINER

(71) Applicant: ZURU (Singapore) Pte. Ltd., Singapore (SG)

(72) Inventor: Mathew Peter MOWBRAY, Coatesville (NZ)

(21) Appl. No.: 17/348,996

(22) Filed: Jun. 16, 2021

(30) Foreign Application Priority Data
Jun. 16, 2020 (SG) 10202005687V

(51) Int. Cl. C11D 17/00; C11D 17/08; C08L 29/04

(52) U.S. Cl. CPC C11D 17/0039; C11D 17/08; C08L 2203/162; C08L 29/04; C11D 17/0008

(57) ABSTRACT

A water-soluble container made up of two halves that seal together, each containing a plurality of chambers that may receive a cleaning substance, commonly a liquid or powder. This container is formed from four, water-soluble, flexible membranes with each half made up of two of the four membranes; a shaped membrane, and a non-shaped membrane, wherein the shaped membrane seals to the non-shaped membrane to form the plurality of physically distinct chambers. Each half is sealed independently to the other half and are subsequently sealed together at their non-shaped membranes to form the water-soluble container resulting in the outer surface of the container to be shaped on both opposing sides.

### TECHNICAL FIELD

This invention relates to the field of pre-dosed detergent pod products generally, and detergent pod products that can be used, for example, in laundry or dishwasher applications.

### DESCRIPTION OF PRIOR ART

All patents, patent applications, published applications and publications, websites and other published materials referred to throughout the entire disclosure herein, unless noted otherwise, are incorporated by reference in their entirety.

U.S. Pat. No. 6,995,126B2 describes a multi-compartment pouch, wherein in a preferred embodiment the pouch is made of water-soluble film and consists of a pre-sealed laundry-detergent-containing, compartment that is then sealed to an open laundry detergent-filled compartment, where when sealed together, both compartments are sealed from the outside environment, and separated distinctly from each other. There are no drawings or details provided of the exact form of the multi-compartment pouch.

U.S. Pat. No. 9,523,066B2 describes a container having a plurality of compartments wherein at least one compartment contains a solid detergent composition and at least one compartment contains a liquid or gel detergent composition. Furthermore, the patent describes each of the container's compartments to preferably be in the form of a polyhedron and arranged in a pattern wherein adjacent compartments are non-superposable and are instead arranged to be interleaved.

U.S. Pat. No. 10,059,912B2 describes a multi-compartment, water-soluble capsule thermoformed by two water-soluble films, with at least two compartments, one surrounding the other, where in the case of two compartments, one should be of larger volume than the other.

### BACKGROUND

The consumer goods category for cleaning products, particularly laundry and dishwasher cleaning products, has many product segments, such as soaps, detergents, whiteners, bleaches, softeners, and stain removers, all of which are available in different forms. These products are available in liquid form, powder form, bulk containers with measuring utensils, and units containing pre-dosed volumes. Additionally, products may be optimised, for example, for hot water use, cold water use, hand wash, automatic washing machines, including top loaders and front loaders, or some products may ensure appropriate use for all aforementioned forms of washing.

Both in the automatic laundry and dishwashing segments, single-use containers of dosed cleaning substances are prevalent in product ranges and are commonly referred to as tablets, tabs, pods, capsules, caps, or pouches. Tablets generally refer to compressed powder shaped into a hard brick and are more common in dishwasher product ranges. Pods, capsules, caps, and pouches generally refer to filled containers made from a clear, flexible, water-soluble membrane, where the filling may commonly be powder, gel, liquid, paste, or similar forms of cleaning substance and are prevalent in both dishwasher and laundry product ranges.

As used hereinafter, when referring to a tablet cleaning product, ‘tablet’ refers to a compressed body of powdered cleaning substance.

As used hereinafter, when referring to a pod cleaning product, ‘pod’ refers to a water-soluble container, containing powder, liquid, gel, or other common cleaning substances, such as those substances used in the laundry and/or dishwasher segments. The water-soluble attribute of the pod results in the container material of the pod dissolving and/or structurally failing, releasing the contained cleaning substance into the surrounding space, when subjected to prolonged water contact, warm water, mechanical stress, or a combination thereof.

Laundry cleaning product ranges mainly include liquid substances, powdered substances, or water-soluble pods. These products come in various packaging types for example: plastic bottles, plastic snap-lid containers, re-sealable bags, cardboard containers.

Dishwasher cleaning product ranges mainly include liquid substances, powdered substances, pods, and tablets. These products come in various packaging types for example: plastic bottles, plastic snap-lid containers, re-sealable bags, cardboard containers.

Tablets and pods are beneficial to consumers by providing a product that easily controls the amount of volume per laundry load. This pre-dosed volume provides a more efficient product at the manufacturing stage as well as for the consumer by reducing tendency of excessive dosing by the user. This helps the consumer save money by ensuring they do not use more detergent per wash cycle than necessary. Additionally, the compact and self-contained form of tablets and pods further reduces risk of powder or liquid spills at the time of usage.

Due to the nature of filled pods and pressed tablets, they both comprise an ability to hold a form, thus providing manufacturers and brands a greater dimension of product design options compared to traditional powder, and liquid detergent containers. This design aid allows more differentiation between competing products and allows the creation of aesthetically pleasing designs, both of which are a benefit to the consumer when selecting a pre-dosed detergent product. The key design capabilities of powder tablets are flexibility in forming various solid 3-dimensional shapes, as well as varying the powder colour. Whereas for liquid pods, multiple cavities can vary the shape of the pod, while additionally each cavity may be filled with liquid of varying colour and/or consistency.

Furthermore, in addition to the tablet and pod construction allowing for purely aesthetic product benefits, the various physical designs can provide technical improvements. Pods, for example, allow for multiple cavities to separate chemicals that may otherwise conflict, or be incompatible. This separation may allow for longer shelf life, more effective performance of said individual chemicals, and other benefits such as separating powders and liquids within one pod. Additionally, different chemicals may be more effective at different times during a wash cycle, potentially allowing for different cavities to preferentially release chemicals upon the water-soluble membrane breaking down.

An additional benefit of pods and tablets is their ability to optimise their physical form in a functional manner. An example of this may be designing a product that is easier to grip by adding texture or grooves in the body. The shape may also be optimised to allow for compact stacking and alignment within a package, reducing the package size to increase transit efficiency. Liquid tablets may also incorporate air bubbles to resist the stress of impacts to reduce risk of failed seals that may result in leaking within a package of pods during transit.

Many pod products currently available to consumers are limited in their product design capabilities by having their shaped compartments layered onto a simply shaped, pre-sealed compartment, limiting the more intricately shaped compartments to be visible from one side only, as well as limiting the control over the 3-dimensional container formed by the combination of these compartments. Furthermore, other commonly available pods consist of multiple compartments but arranged along a flat plane rather than layered, providing a simple pod construction that comprises of only two sealable membranes, however, due to this planar limitation these products generally have a much wider footprint than the aforementioned layered pods, resulting in a flat and limp structure due to the large ratio between the footprint and thickness of the pod. Therein exists a need for a pod that can provide intricately shaped compartments on more than one side of a pod, as well as layer these shaped compartments to form a compact, plurality of chambers wherein these chambers additionally allow for one or more different cleaning substances within said chambers as well as one or more differently coloured cleaning substances.

### SUMMARY OF THE INVENTION

Accordingly, the present invention comprises a container, henceforth referred to as ‘multi-chamber pod’, made from a plurality of flexible membranes. Some of these flexible membranes may be formed to a shape so that when sealed to another flexible membrane, a plurality of chambers are created between said membranes. Each chamber is formed to accommodate a volume of liquid, gel, or powder equal or less to the volume of said chamber and is sealed to be physically distinct, such that their internal volumes are independent from each other and from the environment surrounding the multi-chamber pod.

Additionally, the multi-chamber pod can comprise two halves that seal together at a coupling plane to form the multi-chamber pod, with each half comprising a plurality of chambers that are sealed prior, and independently, to the two halves sealing together, wherein the two separated halves do not require sealing together for the chambers within each half to be sealed from the outside atmosphere or from other chambers within said half.

Furthermore, the multi-chamber pod can be formed with a plurality of flexible membranes, wherein the number of flexible membranes is four, with each half of the multi-chamber pod being formed by two flexible membranes: a shaped membrane and a non-shaped membrane.

Also, the outer surfaces of the two halves can be symmetrical to each other when sealed to form the container. This symmetry can be useful to provide a uniform product design when the multi-chamber pod is viewed from either side. Additionally, this symmetry, when rotationally symmetrical, may be useful for allowing the same moulds to be used to form the shape of the chambers for both halves of the multi-chamber pod, thus improving manufacturing efficiency. Furthermore, this symmetry provides a container such that the shaped outer surfaces of each container half are rotationally or reflectively symmetrical to achieve the aforementioned goals; thus it should be noted that as long as the outer membranes of each half are symmetrical, rotationally or reflectively, the inner membranes of the container, that may not contribute to the container's external shape, may not need be symmetrical for purposes of aiding manufacturing or structure of said container.

In addition, the flexible membranes can be water-soluble, providing the capability for this container to be fit for use in dishwasher and laundry machines.

The substance or substances contained within each chamber may optionally comprise dishwashing or laundry compositions, such as detergents, whiteners, softeners, soaps, stain removers, and/or other common cleaning substances.

The substance contained within each chamber may be an aqueous liquid, a powder, a gel, a paste, a gel with solid particulates, an aqueous liquid with solid particulates or any compositional consistency common place within dishwasher and laundry cleaning substances.

Additional features and advantages of the invention will be set forth in the description which follows, and in part will be apparent from the description, or may be learned by practice of the invention. The objectives and other advantages of the invention will be realised and attained by the structure particularly pointed out in the written description and claims hereof as well as the appended figures.

It is to be understood that both the foregoing general description and the following detailed description are exemplary and explanatory and are intended to provide further explanation of the invention as claimed.

### DESCRIPTION OF THE DRAWINGS

The accompanying drawings, which are included to provide further understanding of the invention are incorporated and constitute a part of this specification, illustrate embodiments of the invention and together with the description, serve to explain the principles of the invention.

In the drawings:

FIG. 1 shows a perspective view of an embodiment of the invention: a sealed multi-chamber pod formed by four flexible membranes.

FIG. 2 displays a perspective view of the embodiment, displaying the first and second halves prior to being sealed together to form the multi-chamber pod.

FIG. 3 shows an exploded perspective view of the embodiment displaying each half and their respective membranes prior to being sealed to form each half.

FIG. 4 shows a side view of the multi-chamber pod separated into the four flexible membranes of FIG. 3.

FIG. 5 shows a top view of the embodiment.

FIG. 6 shows a perspective section view of the embodiment, displaying the multi-chamber pod separated into the four flexible membranes.

FIG. 7 displays a perspective exploded view of a further embodiment of the invention: a multi-chamber pod having four flexible membranes and each shaped membrane being rotationally symmetrical to each other.

FIG. 8 shows a top view of the embodiment from FIG. 7, displaying the top profile of the chambers.

### DETAILED DESCRIPTION OF THE INVENTION

As used hereinbefore or after, when referring to a chamber within a sealed container, “chamber” refers to a space within a container that may contain a solid or liquid volume and is physically sealed from other contained chambers, and the surrounding atmosphere around the container, such that the contained solid or liquid mass contained within said chamber may not leak into any other chambers or the surrounding atmosphere unless said container is accordingly damaged, defective, or purposefully deteriorated to cause such leakage.

As used hereinbefore or after, when referring to a multi-chamber pod, “multi-chamber pod” refers to a pod comprising two halves, each of which comprising a plurality of chambers, with the material of the container comprising of a water-soluble, flexible membrane material.

As used hereinbefore or after, when referring to a half of a multi-chamber pod, “half” respectively refers to one of the two halves of a multi-chamber pod that each comprise a plurality of chambers and are sealed independently, prior to combining to form the multi-chamber pod. These halves may be equal in volume or not equal, but generally similar, in volume.

As used hereinbefore of after, when referring to a longitudinal axis of a multi-chamber pod, “longitudinal axis” refers to an axis parallel to the coupling plane between the pod halves and passing through the pod's geometrical centre.

As used hereinbefore or after, when referring to a longitudinal direction of a multi-chamber pod, “longitudinal” refers to a direction parallel to the longitudinal axis.

As used hereinbefore or after, when referring to a transverse axis of a multi-chamber pod, “transverse axis” refers to an axis parallel to the coupling plane between the pod halves, perpendicular to the longitudinal axis, and coincident to the pod's geometrical centre.

As used hereinbefore or after, when referring to a transverse direction of a multi-chamber pod, “transverse” refers to a direction parallel to the transverse axis.

The invention as disclosed in its present form comprises of: A pod formed from two independently sealed halves, with each half formed from two water-soluble, flexible membranes and each half comprising at least two chambers. The chambers in each half are formed from the two flexible membranes, wherein one membrane is a shaped membrane and one is a non-shaped membrane with the non-shaped membranes of each pod half providing a generally planar surface to seal together to form the pod.

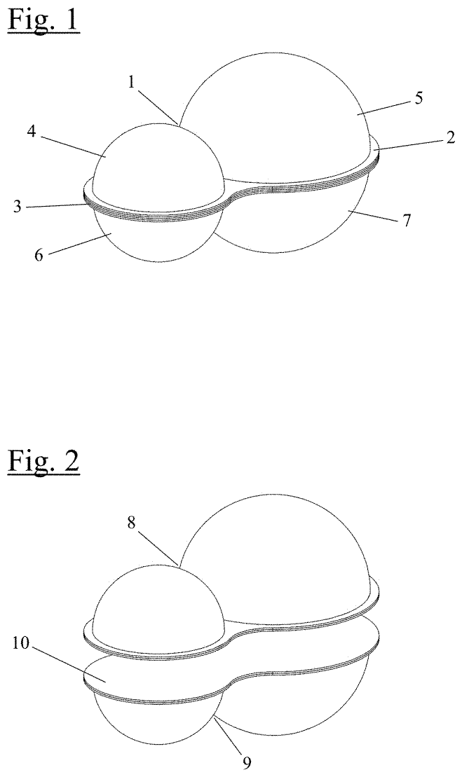

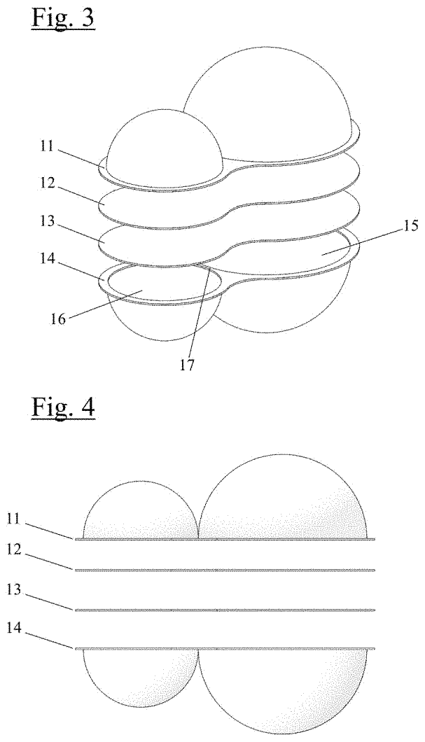

Referring now to FIGS. 1 to 3, this embodiment of a multi-chamber pod 1 comprises four chambers 4, 5, 6, 7 formed by four flexible membranes sealed along the central plane 3 of the pod. This multi-chamber pod comprises of two halves 8, 9 with each containing two chambers formed by two flexible membranes. Each half is sealed independently of the other half prior to sealing together at a coupling face 10 along an area of an outer flange 2 to create a multi-chamber pod 1. The four membranes 11, 12, 13, 14 seal together to form the multi-chamber pod 1 with a first shaped membrane 11 sealing to a first non-shaped membrane 12 to form the first half 8, and a second shaped membrane 14 sealing to a second non-shaped membrane 13 to form the second half 9.

The membranes can be sealed together by any suitable material or technique. For example, the membranes can be seal together via an adhesive material contained therein or applied thereto. Suitable adhesives may include: epoxies, resins, or glues. Alternatively, the membranes can be self-adhered to one another through the application of one or more of mechanical pressure, heat, and/or ultrasonic energy, or the application of water or solvent to partially dissolve each membrane material such that they may self-adhere to each other, or a combination thereof.

Each chamber is independent from other chambers as shown by the chambers 15, 16, within the second half 9, having their enclosed volume separated by a sealed section 17 of the second shaped membrane 14 that seals to the second non-shaped membrane 13 separating the internal volumes of said chambers 15, 16.

FIG. 4 shows a side view of the same embodiment in FIGS. 1-3, displaying the profile of the flexible membranes 11, 12, 13, 14. In this embodiment, the non-shaped membranes 12, 13 are generally planar, however in alternative embodiments the flange of these membranes may be generally planar, while the middle may be concaved toward the shaped membrane it is sealed to.

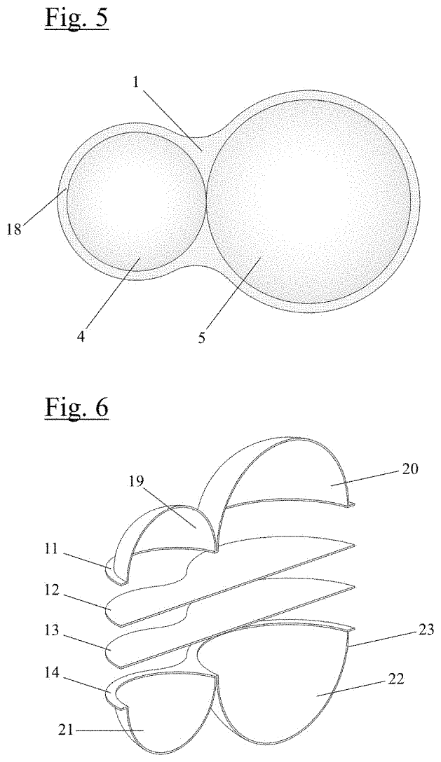

FIG. 5 displays the embodiment from FIGS. 1-4 from a top view, showcasing the multi-chamber pod 1 and two chambers 4, 5 surrounded by a uniform flange 18 where the flange area is sealed to adjacent membranes.

FIG. 6 shows the embodiment from FIGS. 1-5 with each of the flexible membranes 11, 12, 13, 14 in section view. On each shaped membrane 11, 14 the inner surfaces form an independent chamber upon sealing to a respective non-shaped flexible membrane. The inner surfaces 19, 20 each form an independent chamber upon the shaped membrane 11 sealing to the non-shaped membrane 12. The inner surfaces 21, 22 each form an independent chamber upon the shaped membrane 14 sealing to the non-shaped membrane 13. In this section view the wall thickness 23 of the membranes is visibly uniform, or generally uniform wherein the shaped and non-shaped flexible membranes are formed from a sheet of flexible membrane of a particular thickness that provides adequate strength and water-solubility qualities. The membranes can be formed by any suitable material. Optionally, the membranes are made from a suitable polymer. According to one non-limiting example, the membranes are formed from polyvinyl alcohol (PVA).

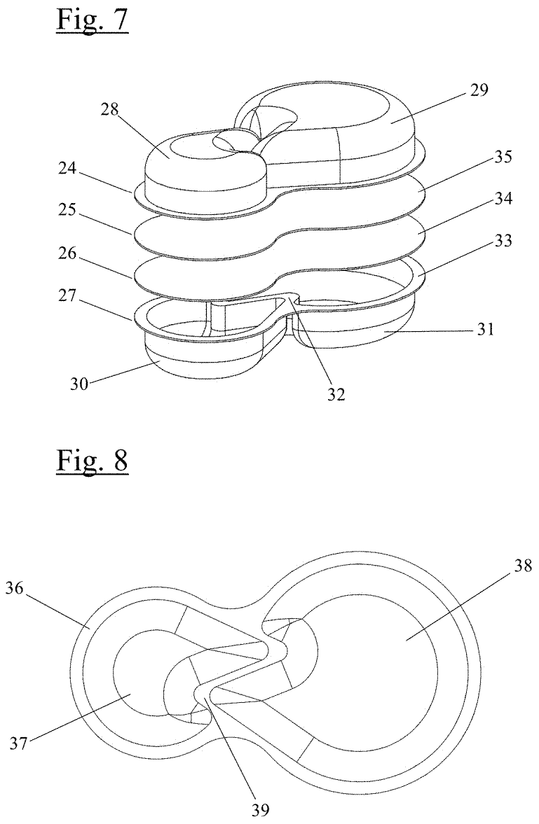

Referring now to FIGS. 7 and 8, these figures display a further embodiment of a rotationally symmetrical multi-chamber pod that comprises four flexible membranes 24, 25, 26, 27 in which the shaped membrane 24 and the non-shaped membrane 25 seal together to form a first half that contains two chambers 28, 29, and the shaped membrane 27 and the non-shaped membrane 26 seal together to form a second half that contains two chambers 30, 31. The first and second half in this embodiment are the same shape, although the profile of each chamber is asymmetrical resulting in each half being rotationally symmetrical to the other when sealed together at their non-shaped membranes 25, 26. The sealing areas in which the shaped membrane and the non-shaped membrane seal together to form a half is what separates the internal volumes of each chamber to be physically distinct from each other, and the surrounding atmosphere. This sealing area 32 between the chambers 30, 31 and the flange face 33 is designed to seal to the outer face of the non-shaped membrane 26 that faces toward the shaped membrane 27. Similarly, the outer face 35 seals to the shaped membrane 24 along the same respective sealing areas of the shaped membrane.

In this embodiment, the area in which the two independently sealed halves seal together to form the multi-chamber pod is along the area of the outer flange 36. The non-shaped membrane 26 seals along the inner face 34 to the non-shaped membrane 25 and its respective inner face along the outer flange area.

In alternative embodiments, it may be preferable for the two halves to be sealed along the outer flange 36 in addition to the dividing area 39 between the chambers 37, 38. This supplementary sealing area may provide additional support to avoid the halves separating, or any potential outward sag from the middle of the pod due to the weight of any contained cleaning substance within the chambers of either half.

The invention has been described with examples relevant to its current form, however, potential embodiments will include any form that is within the scope of the appended claims. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A container comprising a first half and a second half, each of the first half and the second half comprise a plurality of chambers, wherein the first half and the second half mate at a coupling face to form the container wherein the first half and second half of the container are symmetrical to each other.

2. The container as claimed in claim 1, wherein the plurality of chambers within each of the first half and the second half is two.

3. The container as claimed in claims 1, wherein the symmetry between the first half and second half is reflection symmetry relative to the coupling face.

4. The container as claimed in claims 1, wherein the symmetry between the first half and the second half is rotational symmetry about an axis parallel a longitudinal direction of the container and coincident to the coupling face.

5. The container as claimed in claims 1, wherein the symmetry between the first half and the second half is rotational symmetry about an axis parallel to the container's transverse direction and coincident to the coupling face.

6. The container as claimed in claim 1, wherein the chambers of both the first half and second half are filled with any of the following cleaning substances: detergents, soaps, whiteners, or softeners.

7. The container as claimed in claim 6, wherein one or more of the cleaning substances within each chamber is a liquid.

8. The container as claimed in claim 1, wherein each of the first half and the second half comprise two polymer films mated together to create an outer surface with the plurality of chambers enclosed within.

9. The container as claimed in claim 1, wherein the container is formed from a material comprising Polyvinyl Alcohol (PVA).

10. A container comprising:
a first flexible membrane;
a second flexible membrane;
a first half comprising a plurality of sealed chambers, wherein said first half is formed by the first flexible membrane and the second flexible membrane, wherein the first flexible membrane is planar, parallel to a first coupling plane, and the second flexible membrane is shaped to form the plurality of sealed chambers when mated to the first flexible membrane coincident to the first coupling plane;
a third flexible membrane;
a fourth flexible membrane;
and a second half comprising a plurality of sealed chambers, wherein said second half is formed by the third flexible membrane and the fourth flexible membrane, wherein the third flexible membrane is planar, parallel to a second coupling plane, and the fourth flexible membrane is shaped to form the plurality of sealed chambers when mated to the third flexible membrane coincident to the second coupling plane,
wherein said second half is mated to the first half coincident to a third coupling plane between the first and third flexible membranes and parallel to the first and second coupling planes.

11. The container as claimed in claim 10, wherein an outer surface of the shaped second membrane is reflectively symmetrical to an outer surface of the shaped fourth membrane, relative to the third coupling plane.

12. The container as claimed in claim 10, wherein an outer surface of the shaped second membrane is rotationally symmetrical, to an outer surface of the shaped fourth membrane, about an axis parallel to the container's longitudinal direction and coincident to the third coupling plane.

13. The container as claimed in claim 10, wherein an outer surface of the shaped second membrane is rotationally symmetrical, to an outer surface of the shaped fourth membrane, about an axis parallel to the container's transverse direction and coincident to the third coupling plane.

14. The container as claimed in claim 10, wherein the number of chambers within each of the first half and the second half is two.

15. The container as claimed in claim 10, wherein the chambers of both the first half and the second half are filled with any of the following cleaning substances: detergents, soaps, whiteners, or softeners.

16. The container as claimed in claim 15, wherein one or more of the cleaning substances within each chamber is a liquid.

17. The container as claimed in claim 10, wherein the four flexible membranes are formed from a material comprising Polyvinyl Alcohol (PVA).
